(19) United States
(12) Patent Application Publication
(10) Pub. No.: US 2003/0017271 A1
(43) Pub. Date: Jan. 23, 2003

(54) Pigment composition

(75) Inventors: Rein Sikkar, Floda (SE); Olof Eriksson, Goteborg (SE); Michael Persson, Vastra Frolunda (SE)

Correspondence Address: Law Offices of David J. Serbin, Unit 2 - First floor, 1423 Powhatan Street, ALEXANDRIA, VA, 22314, US

(73) Assignee: AKZO NOBEL N.V.

(21) Appl. No.: 10/179,296

(22) Filed: Jun. 26, 2002

Related U.S. Application Data
(60) Provisional application No. 60/301,836, filed on Jul. 2, 2001.

(51) Int. Cl. C09C 1/02; C09C 1/36; B05D 3/02

(52) U.S. Cl. 427/372.2; 106/499; 106/468; 106/447; 106/465

(57) ABSTRACT

The invention relates to an aqueous slurry or dispersion of pigment particles comprising as dispersant an amphiphilic polymer at least partly adsorbed to the pigment particles, wherein the slurry or dispersion exhibits a temperature dependent viscosity in such way that the viscosity increases at least with a factor of about 2 when the temperature is raised from about 20 up to about 100° C. The invention further relates to a the preparation of the slurry or dispersion, a coating color composition, a process for its preparation, and a process for preparing coated paper or board.

The present invention relates to a slurry or dispersion of pigment particles comprising as dispersant an amphiphilic polymer and the preparation thereof. The invention further relates to a coating colour composition, a process for its preparation, a process for preparing coated paper or board, and paper or board obtainable by the process.

Paper is frequently coated in order to impart certain desired properties to the paper. For example, a surface suitable for printing or having improved gloss characteristics is often desirable.

It is often desired that the paper surface should exhibit a certain degree of gloss in order to be aesthetically pleasing, and also from a printing point of view. Gloss can be imparted mechanically by calendering of the paper. However, during calendering the bulk of the paper will be reduced, which leads to a less rigid paper structure that is more pliant and flexible. This secondary effect of extensive calendering in order to obtain gloss is however not always desired.

Conventional coating colour compositions for paper usually comprise a slurry or dispersion of pigment particles together with various additives. The coating colour composition is usually prepared by first providing a dispersion or slurry of pigment particles together with one or more dispersants, and then mixing this dispersion or slurry with additives such as a binder (e.g. latex or starch) and rheological agents such as co-binders or thickening agents (e.g. CMC). Additionally, optical brightening agents can be included, and other conventionally used additives such as, pH adjusting agents, foam depressants, lubricants, preservatives, insolubilisers, etc.

The use of a high solid substance content coating colour normally leads to less energy being required for the drying of the coated paper and possibly less tendency of migration of water and binder into the paper web. The total coating operation will thereby be faster.

The pigment particles are generally small, weakly charged particles, e.g. with an average diameter from about 0.2 to about 1 μm. When suspended in water, the particles will have a tendency to aggregate due to the attractive forces if these are stronger than the repulsion forces. Thus, when the solid substance level increases in the pigment slurry, agglomeration or other problems of dispersing the pigments are likely to occur. The addition of one or more dispersants is therefore necessary. Commonly used dispersants are predominantly anionic, charged polymers, such as polyacrylic acids (PAA) and polyphosphates. Typically, the addition of dispersant will lower the viscosity to a certain point, after which any further addition of dispersant, due to the inherent viscosity of the dispersant, will lead to a significantly increased viscosity. Thus, there will generally be an optimum concentration of the dispersant, corresponding to the minimum viscosity of the pigment slurry for a given solid substance level thereof. For a given dispersant, this concentration will be mostly dependent on the type of pigment used.

Furthermore, if, for example, a highly charged dispersant (e.g. PAA) is used in large amounts, any coated broke obtained will consequently contain high levels of heavily charged species, which, when re-introduced at the wet end of the paper machine, will interfere with the function of flocculants, and other agents used therein.

Many polymers in solution, especially electrically non-charged ones, exhibit a temperature dependent viscosity in such a way that the viscosity of the solution increases significantly above a certain temperature and the polymer finally starts gelling or precipitating due to associations of the polymer chains. The significantly increased viscosity is explained by hydrophobic interaction between the polymer chains caused by gradual destruction of the water shell around the polymers. As the temperature is elevated further, the hydrogen bonds are successively eliminated, and water molecules are thereby released. Larger aggregates of associated polymer chains are also formed, minimising the total area of the polymer chains exposed to water. In the case of non-charged polymers, the temperature at which the significant viscosity increase starts, can be raised by the addition of surfactants so the non-charged polymer molecules will behave as charged molecules by virtue of the surfactants ions attracted thereto and no significant viscosity increase will occur below, for example, 100° C.

It has been disclosed in U.S. Pat. No. 6,117,491 and U.S. Pat. No. 6,123,996 to use polymers, whose viscosity increase at heating, as a thickening agent in paper coating compositions. Similar compositions are also disclosed in EP-A-359349.

It is an object of the invention to provide a dispersion or slurry of pigment particles that has low viscosity but high solids content.

It is another object of the invention to provide a coating colour compositions based on such a dispersion or slurry, that immobilises rapidly on a paper or paperboard surface.

It is still another object of the invention to provide a process of preparing coated paper or paperboard having a surface suitable for printing or high gloss characteristics, without, for example, extensive calendering.

One aspect of the present invention concerns an aqueous slurry or dispersion of pigment particles comprising as dispersant an amphiphilic polymer at least partly adsorbed to the pigment particles, wherein the slurry or dispersion exhibits a temperature dependent viscosity in such way that the viscosity increases at least with a factor of about 2, preferably at least with a factor of about 5, most preferably at least with a factor of about 10 when the temperature is raised from about 20 up to about 100° C., preferably from about 30 up to about 80° C., most preferably from about 40 up to about 70° C. Continued heating to higher temperatures finally leads to destabilisation and intense aggregation of the system.

The solids content of slurry or dispersion is suitably above about 60 wt %, preferably above about 70 wt %. The upper limit is only set by the viscosity, which below about 20° C., preferably below about 30° C. should be sufficiently low for the slurry or dispersion to be possible to pump. Below about 20° C. the Brookfield viscosity is preferably from about 50 to about 1000 mpas, most preferably from about 50 to about 200 mPas. In practice, it may then be difficult to provide useful slurries or dispersions with a solids content exceeding about 80 wt %.

The pigment particles are suitably weakly charged and preferably inorganic, such as clay (e.g. kaolin), TiO₂, calcium carbonate, or mixtures thereof. By the use of clay, gloss can generally more easily be imparted to the paper. Calcium carbonate, on the other hand, is less expensive and inherently often exhibits a brighter colour. Calcium carbonate can, for example, be used in the form of precipitated calcium carbonate (PCC) or ground calcium carbonate (GCC) e.g. ground lime stone, marble or chalk. The present invention has been found to be particularly favourable when PCC is used as pigment particles, which particles generally are difficult to disperse due to their narrow particle size distribution.

The average particle diameter of the pigment particles is suitably from about 0.1 to about 2 μm, preferably from about 0.2 to about 1 μm.

The term dispersant as used herein refers to chemicals participating in the deflocculation process of the pigment particles. Thus, the dispersant reduce the energy necessary to separate the pigment into discrete particles, provide stability that prevents agglomeration upon storage and decrease the viscosity at high solids content. In contrast to chemicals usually classified as surfactants, the dispersants preferably have only little effect on surface tension, only little wetting action, low foaming, but high deflocculation power. In contrast to thickening agents that normally are totally dissolved in the water, the dispersants of this invention are at least partially adsorbed to the pigment particles.

The amphiphilic polymer used as dispersant preferably has an average molecular weight from about 2000 to about 200000, more preferably from about 3000 to about 100000, and most preferably from about 5000 to about 20000.

The dispersants to be used in the invention have different structure from PAA, and are, as opposed to the hydrophilic PAA, amphiphilic polymers, i.e., contain both hydrophilic and hydrophobic groups. The hydrophilic groups are preferably selected from charged anionic moiety, PEO/PPO (polyethylene oxide/polypropene oxide), or mixtures there of. In a preferred class of polymers at least some of the hydrophilic groups are charged, which groups most preferably are selected from inorganic or organic acidic residues such as sulphonates, phosphonates, carboxylates, or mixtures thereof. Preferred polymers are copolymers, comprising hydrophilic and hydrophobic residues, which residues preferably are alternating along a backbone, while hydrophilic, preferably charged, anchoring groups are positioned along the backbone. The hydrophobic residues are preferably C₄ to C₂₀, most preferably C₄-C₁₈ carbon chains. The hydrophilic residues suitably comprise PEO/PPO chains or segments along the polymer backbone. The hydrophilic residues preferably comprise from about 5 to about 50 EO/PO units, most preferably from about 20 to about 50 EO/PO units.

It has been found that those amphiphilic polymers of the invention that per se do not exhibit a significant viscosity increase between about 20 to about 100° C., do so when partially adsorbed to the pigment particles. If the polymer is charged, it is believed that some of the charges are neutralised by adsorbing to the surface of the pigment particles, while the polymer will retain its dispersing action by virtue of residual charges. Thus, adsorption to the surface through partial electrical neutralisation, and remaining electrical charges on the pendant chains is a feature of the preferred polymers of the invention. However, also amphiphilic polymers that per se exhibit a significant viscosity increase between about 20 to about 100° C. can be used in the invention provided they are effective as dispersants and exhibit such temperature dependent viscosity properties also when at least partially adsorbed to the pigment particles.

At temperatures below about 20° C., the hydrophilic and hydrophobic tails of the polymers are reaching out from the surface of the pigment particle, thereby creating electrosteric or steric stabilisation. By virtue of the latter form of stabilisation, the polymers of the present invention are believed to be less sensitive to the presence of salt than polymers only relying on an action of stabilisation via electrical charges.

According to a preferred embodiment, the dispersing agent is an acrylic ester copolymer having pendant hydrophobic chains, hydrophilic chains, and exhibiting phosphonic acid or carboxylic acid as anions. The pendant hydrophobic chains are preferably C₄-C₂₀, and most preferably C₄-C₁₈ carbon chains. Said hydrophilic chains preferably comprise alkylene oxide groups, preferably EO (ethylene oxide) and/or PO (propylene oxide) groups, more preferably 2 to 50, and most preferably 10-30 EO and/or PO groups. It is preferred that the alkylene oxide groups are only EO groups, or essentially only EO groups. Phosphonate groups in the polymer will give rise to a strong adsorption to calcium carbonate particles.

According to another preferred embodiment, the dispersant is selected from hydrophobically modified carboxymethyl cellulose (HM-CMC). Particularly preferred HM-CMC polymers are those obtainable by a process comprising reacting an alkali metal cellulose with at least three alkylating reagents A, B, and C;

one or more reagents A being selected from the group of haloacetic acids, alkali metal haloacetates, alkali metal vinyl sulfonates, and vinyl sulfonic acid;

one or more reagents B having the formula R¹-(OCH₂CH(R²))ₙ-P, wherein R¹ represents a C₂-C₇ group, R² is hydrogen or a methyl group, n is 0-2, and P represents a glycidyl ether group, a 3-halo-2-hydroxypropyl ether group, a 1,2-epoxy group, or a halide; and

one or more reagents C having the formula R³-(OCH₂CH(R²))ₘ-P wherein R³ represents a C₈-C₃₀ group, m is 0-10, and R² and P have the meaning as described above. Such HM-CMC polymers are described in more detail in WO 98/56825.

Alternatively copolymers based on polyurethane chemistry can be used as dispersants, such as those described in U.S. Pat. No. 4,096,127 or U.S. Pat. No. 4,777,224, i.e. polyurethane copolymers exhibiting at least one carboxylic acid residue as an anionic moiety. As a further alternative, copolymers based on alfa-olefin/maleic acid anhydride chemistry can be used as dispersants, such as those described in U.S. Pat. No. 4,931,197, and especially in Example 1 therein, i.e. alpha olefin/maleic acid copolymer exhibiting at least one carboxylic acid residue as an anionic moiety.

The polymers used as dispersant can also be based on any chemistry being able to create copolymers exhibiting similar hydrophobic and hydrophilic parts wherein the anionic anchoring group may comprise any suitable acidic functionality, e.g. natural polymers like carbohydrates modified by introducing charged groups along the backbone or grafted with hydrophobic and hydrophilic tails, as exemplified by the earlier mentioned hydrophobically modified carboxymethyl cellulose.

It is to be understood that the slurry or dispersion may comprise one or more amphiphilic polymer as described above, optionally in combination with one or more other dispersing agents.

The slurry or dispersion suitably has a solids content from about 40 to about 80 wt %, preferably from about 60 to about 75 wt %, of which the main part, preferably substantially all, is made up of pigment particles. It suitably comprises, as dispersant, from about 0.1 to about 4 wt % based on dry pigment, preferably from about 0.1 to about 2 wt % based on dry pigment of one or more amphiphilic polymer as described above. The water content is suitably from about 20 to about 60 wt % based on dry pigment, preferably from about 25 to about 40 wt % based on dry pigment. The content of other component is preferably less than about 0.5 wt % based on dry pigment, most preferably less than about 0.1 wt %.

The invention further concerns a process for the preparation of a slurry or dispersion as described above comprising a step of mixing pigment particles, water and an amphiphilic polymer that becomes at least partly adsorbed to the pigment particles to obtain a slurry or dispersion exhibiting a temperature dependent viscosity as earlier described.

The invention also concerns a coating colour composition comprising a slurry or dispersion as described above and at least one additive selected from the group consisting of binders, co-binders, rheology modifiers, foam depressants, optical brightening agents, pH adjusting agents, lubricants, preservatives and insolubilisers, wherein the coating colour composition exhibits a temperature dependent viscosity as defined in the above description of the slurry or dispersion. Thus, the viscosity increases at least with a factor of about 2, preferably at least with a factor of about 5, most preferably at least with a factor of about 10 when the temperature is raised from about 20 up to about 100° C., preferably from about 30 up to about 80° C., most preferably from about 40 up to about 70° C.

As for the slurry or dispersion per se, as described above, the properties of exhibiting a significant viscosity increase between about 20 and about 100° C. depends on the presence of the amphiphilic polymer as dispersant that is at least partially adsorbed to the pigment particles.

The solids content of the coating colour composition is suitably above about 50 wt %, preferably above about 60 wt %. The upper limit is only set by the viscosity, which below about 20° C., preferably below about 30° C. should be sufficiently low for the composition to be applied to the surface of paper or paperboard. Below about 20° C. the Brookfield viscosity is preferably from about 50 to about 5000, most preferably from about 50 to about 3000 mpas. In practice, it may then be difficult to provide useful slurries or dispersions with a solids content exceeding about 80 wt %.

The amphiphilic polymer used as dispersant is preferably present in the coating colour composition in an amount, based on 100 pph (part per hundred) pigment particles, from about 0.05 to about 10 pph, preferably from about 0.1 to about 5 pph, most preferably from about 0.1 to about 2 pph. If the solids content is low, for example below about 60 wt %, also the amount of dispersant can in some cases be lower than the above figures, while higher amounts sometimes may be required for compositions of high solids content. A suitable amount of dispersant to be included can in each case be established by person skilled in the art merely by routine experimentation.

The compositions preferably comprise from about 5 to about 25 pph of one or more binders. Any conventional binder can be used, such as starch, latex, protein, polyvinyl alcohol, and mixtures thereof.

The compositions preferably comprise from about 0.1 to about 5 pph of one or more co-binders or rheology modifiers. Any conventional co-binder can be used, such as carboxy methyl cellulose (CMC), other cellulose derivatives, polyvinyl alcohol, sodium alginate, alkali-swelling polyacrylates, and mixtures thereof.

The compositions preferably comprise from about 0.1 to about 5 pph of other additives. Any conventional additive can be used, such as foam depressants, dispersants (in addition to the amphiphilic polymer at least partly adsorbed to the pigment particles), optical brightening agents (OBA), lubricants, pH adjusting agents, insolubilisers, etc. All these additives are conventional and can easily be selected by those skilled in the art.

A particularly preferred composition of the invention comprise, based on 100 parts of pigment and calculated on a dry solids content on a weight basis: pigments, 100 pph; amphiphilic polymer as dispersant, from about 0.1 to about 4 wt pph, most preferably from about 0.1 to about 2 pph; binders, from about 5 to about 25 pph, most preferably from about 10 to about 15 pph; co-binders or rheology modifiers, from about 0.1 to about 4 pph, most preferably from about 0.5 to about 2 pph; other additives, from about 0.1 to about 5 pph, most preferably from about 0.1 to about 2 pph.

The invention further concerns a process for the preparation of a coating colour composition of the invention comprising the step of mixing a slurry or dispersion of pigment particles as earlier described with at least one additive selected from the group consisting of binders, co-binders, rheology modifiers, foam depressants, optical brightening agents, pH adjusting agents, lubricants, preservatives and insolubilisers.

The invention further concerns a process for the preparation coated paper or paperboard comprising the steps of applying a coating colour composition as described above to a paper or paperboard web followed by bringing said coating colour composition to a temperature sufficient for increasing the viscosity at least with a factor of about 2, preferably at least with a factor of about 5, most preferably at least with a factor of about 10, which temperature suitably is above about 20° C., preferably above about 30° C., most preferably above about 40° C. Thereby the coating will be rapidly immobilised on the paper or paperboard, inhibiting any flow of the coating ingredients.

The amount applied is not critical and can be any conventionally used amount, such as for example from about 1 to about 50 g/m2, preferably from about 3 to about 25 g/m2, calculated as dry solids per side of the paper or paperboard.

Coating can be performed either on machine or off machine. In either case different types of coating methods can be used, some of which are more suitable in the case of off-machine coating, and others in the case of on-machine coating. For example, blade coating is conveniently used in both cases, whereas air knife coating, roll coating, size press coating and cast coating are normally only used in on machine coating. The predominantly used method, however, is blade coating.

During coating, the colour is normally initially applied to the paper surface in a considerable excessive amount, for example by passing the paper web on a roll into a tray containing the coating colour, such as by means of a roll applicator. Alternatively, a jet applicator can be used. In the case of blade coating, an excessive amount of coating colour is removed from the paper by the scraping or wiping action of a blade, normally of metal, pressing continuously against the surface of a roll or cylinder. A number of different blade coating units have been developed, the principle underlying the method of blade coating, however, remains essentially the same. The coating colour of the present invention can be used in all conventional coating methods, both on and off machine, of which blade coating and size press coating, especially blade coating, are preferred.

After coating, the paper is dried, which in the case of on machine coating normally is accomplished in the drying section of the machine. Conventionally used means of drying in the drying section, such as infra red radiation, hot air, heated cylinders or any combination thereof, may be used. The means of drying is not critical to the invention. The temperature for the viscosity to increase significantly, resulting in immobilisation of the coating colour, is preferably reached when the paper is subjected to heat for drying thereof, for example by means of infrared radiation.

By using the specified polymers of the invention as dispersant to the pigment particles, it has unexpectedly been found that the gloss can be markedly improved. Other qualities are also unexpectedly improved. For example, a more even distribution of the binder of the colour throughout the surface of the coated paper is obtained, leading to a reduced mottling phenomenon. The colour density obtained when the paper is printed is also increased. An improved cohesion within the applied and dried coating has also been observed. Thus, reduced cracking of the coating has been observed when the paper of the invention is folded or creased.

Many polymers of the invention when adsorbed onto pigment particles (as opposed when in solution in absence of such particles) may show an increase in the storage modulus (G′) when heating by a factor of about 100 or 1000 or even 10000 or more when measured on a rheometer at low oscillatory shear. At that point, the water phase is basically expelled from the coating colour creating a gel-like structure.

Furthermore, by using polymers as dispersants according to the invention, the coating can be brought to immobilise essentially instantaneously on a paper surface when heated. Accordingly, the coating systems of the invention can be designed to immobilise at a desired temperature and thereby customised to each individual paper machine.

Moreover, the phenomenon of mottling, which is partly due to migration of binder and pigments from the coating into the base paper after coating, and any additional migration also in opposite direction during drying of the coated paper, can be substantially reduced by use of the coating colour of the present invention.

In some cases it might also be possible to prepare coating colour compositions with a high solids substance level, thus requiring a shorter period of time for drying the paper after coating thereof, which in turn would speed up the manufacturing process and lead to a reduced energy consumption. However, at such high solids substance levels, in combination with high velocity of the paper machine, it must be secured that shear thickening of the colour is avoided when high shear forces are experienced.

As mentioned above, it is possible to prepare paper or paperboard with better properties than with prior art method. Thus, the invention also concerns paper or paperboard obtainable by the method described above.

The invention will now be further described through the following Examples. Dispex™, comprising a conventional anionic, sodium polyacrylate, is used as the reference dispersant herein. Calculated on a weight basis, higher amounts are required of the dispersants of the invention in order to reach the same low viscosity. Calculated on a charge basis the dispersants of the invention are more effective. In the examples coating was performed both in a pilot-scale coating machine as well as in a laboratory coater. If not otherwise stated all percentages and parts refer to percent and parts by weight.

### EXAMPLE 1 (Comparative)

A coating colour of a total solids content of 60 wt % was prepared by uniformly blending 3.38 g (0.9%) of a 40% aqueous solution of a sodium polyacrylate dispersing agent (Dispex™ N40 manufactured by Ciba Specialty Chemicals), 86.32 g of deionized water, 0.1 g of antifoam (Coatosil™ 1378 manufactured by Witco), 150 g of scalenohedral precipitated calcium carbonate manufactured by Huber Engineered Materials, 33.33 g (11%) of a 50% dispersion of SB latex (Baystal P7105 manufactured by Eka Polymer Latex) and 8.40 g (0.6%) of a 10% aqueous solution of CMC (Finnfix™ 10 manufactured by Noviant).

### EXAMPLE 2 (Comparative)

A coating colour of a total solids content of 60 wt % was prepared by uniformly blending 1.08 g (0.15%) of a 10% aqueous solution of a sodium polyacrylate dispersing agent (Dispex™ N40 manufactured by Ciba Specialty Chemicals), 48.98 g of deionized water, 0.1 g of antifoam (Coatosil™ 1378 manufactured by Witco), 72 g of rhombohedral precipitated calcium carbonate manufactured by Huber Engineered Materials, 16.06 g (11%) of a 50% dispersion of SB latex (Baystal™ P7105 manufactured by Eka Polymer Latex) and 4.02 g (0.6%) of a 10% aqueous solution of CMC (Finnfix™ 10 manufactured by Noviant).

### EXAMPLE 3

A coating colour of a total solids content of 60 wt % was prepared by uniformly blending 30.0 g (2%) of a 10% aqueous solution of a styrene acrylic butyl ester comb copolymer containing both PEO/PPO combs and phosphonic acid as anchoring group with a molecular weight distribution between 5000 and 30000 g/mol as dispersing agent, 62.68 g of deionized water, 0.1 g of antifoam (Coatosil™ 1378 manufactured by Witco), 150 g of scalenohedral precipitated calcium carbonate manufactured by Huber Engineered Materials, 33.33 g (11%) of a 50% dispersion of SB latex (Baystal P7105 manufactured by Eka Polymer Latex) and 8.48 g (0.6%) of a 10% aqueous solution of CMC (Finnfix™ 10 manufactured by Noviant).

### EXAMPLE 4

A coating colour of a total solids content of 60 wt % was prepared by uniformly blending 9.90 g (1.1%) of a 17% aqueous solution of a polyurethane based copolymer containing both PEO segments, C₁₆ alkyl groups and carboxylic acid as anchoring group (as described in U.S. Pat. No. 4,777,224) as dispersing agent, 87.30 g of deionized water, 0.1 g of antifoam (Coatosil™ 1378 manufactured by Witco), 150 g of rhombohedral precipitated calcium carbonate manufactured by Huber Engineered Materials and 33.33 g (11%) of a 50% dispersion of SB latex (Baystal™ P7105 manufactured by Eka Polymer Latex).

### EXAMPLE 5

A coating colour of a total solids content of 60 wt % was prepared by uniformly blending 2.74 g (0.75%) of a 20% colloidal dispersion of a polyurethane copolymer (Jetsize™ AP15 manufactured by Eka Chemicals), 48.03 g of deionized water, 0.1 g of antifoam (Coatosil™ 1378 manufactured by Witco), 72 g of rhombohedral precipitated calcium carbonate manufactured by Huber Engineered Materials, 16.06 g (11%) of a 50% dispersion of SB latex (Baystal™ P7105 manufactured by Eka Polymer Latex) and 4.04 g (0.6%) of a 10% aqueous solution of CMC (Finnfix™ 10 manufactured by Noviant).

### EXAMPLE 6 (Comparative)

A coating colour of a total solids content of 60 wt % was prepared by uniformly blending 0.96 g (0.15%) of a 10% aqueous solution of a sodium polyacrylate dispersing agent (Dispex™ N40 manufactured by Ciba Specialty Chemicals), 2.43 g (0.75%) of a 20% colloidal dispersion of a polyurethane copolymer (Jetsize™ AP15 manufactured by Eka Chemicals), 50.78 g of deionized water, 0.1 g of antifoam (Coatosil™ 1378 manufactured by Witco), 64 g of rhombohedral precipitated calcium carbonate manufactured by Huber Engineered Materials, 14.28 g (11%) of a 50% dispersion of SB latex (Baystal™ P7105 manufactured by Eka Polymer Latex) and 3.60 g (0.6%) of a 10% aqueous solution of CMC (Finnfix™ 10 manufactured by Noviant).

### EXAMPLE 7 (Comparative)

A coating colour of a total solids content of 60 wt % was prepared by uniformly blending 0.56 g (0.3%) of a 40% aqueous solution of a sodium polyacrylate dispersing agent (Dispex™ N40 manufactured by Ciba Specialty Chemicals), 43.46 g of deionized water, 0.1 g of antifoam (Coatosil™ 1378 manufactured by Witco), 75 g of kaolin clay (Speswhite™ manufactured by Imerys), 16.67 g (11%) of a 50% dispersion of SB latex (Baystal™ P7105 manufactured by Eka Polymer Latex) and 4.18 g (0.6%) of a 10% aqueous solution of CMC (Finnfix™ 10 manufactured by Noviant).

### EXAMPLE 8

In this example, the temperature dependent behaviour of the PCC colour from Example 3 and a conventional PCC colour (Comp. Example 1), were examined using a rheometer model UDS200 from PAAR Physica. The temperature tests were performed between 25 and 85° C. within the linear viscoelastic region.

TABLE 1
The storage modulus at various temperatures for coatings from
Comparative Example 1 and Example 3.

| | |
|---|---|
| Temperature | Storage modulus, |
| (° C.) | G′ (Pa) |

Coating of Comp. Example 1

| | |
|---|---|
| 25 | 155 |
| 35 | 47 |
| 45 | 47 |
| 55 | 64 |
| 65 | 68 |
| 75 | 64 |
| 85 | 81 |

Coating of Example 3

| | |
|---|---|
| 25 | 11 |
| 35 | 13 |
| 45 | 22 |
| 55 | 171 |
| 65 | 2110 |
| 75 | 4820 |
| 85 | 9010 |

An aqueous solution of 1 wt % of the polymer used as dispersing agent in Example 3, on the other hand, did not show any visual precipitation during a temperature increase from 20-95° C., i.e. no clouding was observed.

### EXAMPLE 9

In this example, a PCC colour containing a polymer of the invention from Example 3 and a conventional PCC colour (Comp. Example 1) were each applied to a sheet of paper according to the conditions shown in table 2 and the physical properties of the coated paper sheets were measured after drying.

TABLE 2
Application conditions.

| | |
|---|---|
| Application | Helicoater, 1000 rpm |
| Drying | IR-heating and hot air |
| Coating amount | 14 g/m² |
| Calendering | Kleinenefers-calendar, 200 m/min, 80° C., 200 kN/m |

The surface roughness (PPS-10) was measured according to SCAN-P 21. The gloss was measured using a micro-gloss 75° meter from BYK-Gardner. The colour density is a mean value of yellow, cyan, magenta and black measured on ink-jet print using a GRETAG D19C densitometer from GretagMacbeth. The contact angle was measured after 10 seconds using a DAT 1100 from Fibro. The variation of latex on the surface has been analysed using a Chromatoscanner from Shimadzu, Japan. High value represents unnevenly latex distribution. Mottling, uneven ink absorption at offset print, was also measured. A high value represents uneven ink absorption. The results of testing are shown in table 3.

TABLE 3
Physical properties of coated paper sheets.

| | None | Calendered | | | | |
|---|---|---|---|---|---|---|
| | calendered | | | | Standard | |
| | PPS-10 | Gloss | Colour | Contact angle | deviation in | Mottling |
| Dispersant | (μm) | unit (%) | density | after 10 sec (°) | amount of latex | 1-8 mm |
| Comp. | 4.62 | 38.7 | 0.85 | 64 | 4853 | 5.09 |
| Example 1 | | | | | | |
| Example 3 | 3.76 | 42.0 | 0.90 | 81 | 2875 | 4.66 |

### EXAMPLE 10

In this example, the temperature dependent behaviour of PCC colour of Example 4 and a conventional PCC colour (Comp. Example 1) were examined using a rheometer model UDS200 from PAAR Physica. The temperature tests were performed and 85° C. within the linear viscoelastic region.

TABLE 4
The storage modulus at various temperatures for Comp. Example 1
and Example 4.

| | |
|---|---|
| Temperature | Storage modulus, |
| (° C.) | G′ (Pa) |

Comp. Example 1

| | |
|---|---|
| 25 | 155 |
| 35 | 47 |
| 45 | 47 |
| 55 | 64 |
| 65 | 68 |
| 75 | 64 |
| 85 | 81 |

Example 4

| | |
|---|---|
| 25 | 81 |
| 35 | 246 |
| 45 | 1060 |
| 55 | 2740 |
| 65 | 6320 |
| 75 | 9700 |
| 85 | 15000 |

### EXAMPLE 11

In this example, the PCC colour of Example 5, the PCC colour of Comp. Example 6, containing a combination of the polymer of the invention and a conventional dispersing agent, and a conventional PCC colour from Comp. Example 2, were compared. The colours were each applied to a sheet of paper using a draw-down coating applicator and the gloss value of the coated paper sheets were measured after drying and soft calendering. The results of the testing are shown in table 5.

The gloss was measured using a micro-gloss 75° meter from BYK-Gardner. The contact angle was measured after 10 seconds using a DAT 1100 from Fibro. The colour density is a mean value of yellow, cyan, magenta and black measured on ink-jet print using a GRETAG D19C densitometer from GretagMacbeth.

TABLE 5
The gloss value of coated paper.

| | Gloss value for soft | Colour | Contact angle at |
|---|---|---|---|
| Designation | calendered paper | density | 10 sec (°) |
| Comp. Example 2 | 34 | 1.13 | 91 |
| Example 5 | 39 | 1.14 | 95 |
| Comp. Example 6 | 35 | 1.10 | 84 |

As can be seen from Table 5, although a polymer of the invention was used in Comp. Example 6, (a colloidal dispersion of a polyurethane copolymer (Jetsize™ AP15 manufactured by Eka Chemicals)), a coating having the desired properties was not obtained. This is assumed to be due to that the desired action of the polymer used in the invention is prevented by the presence of a species interfering with the mechanisms underlying the achievement of such action. As mentioned above, said action is presently believed to be based on the association of the polymer of the invention with the pigment particles, and thus, the desired result is likely to be prevented from being obtained by the presence of the conventional polyacrylate dispersing agent in the colour. Accordingly, it is preferred to only use polymers of the invention as dispersing agent in the coating colour of the invention.

### EXAMPLE 12

In this example, a PCC colour of the invention (Example 3) and a conventional PCC colour (Comp. Example 1) were each applied to a plastic film. The coating layer could be separated from the film, the mechanical properties was measured using an Alwetron TH1 from Lorentzon & Wettre. The elongation and the tensile energy absorption were measured.

TABLE 6
The elongation of coated layer.

| Designation | Elongation (%) | Tensile energy absorption (J/m²) |
|---|---|---|
| Comp. Example 1 | 0.6 | 0.6 |
| Example 3 | 2.9 | 1.8 |

### EXAMPLE 13

In this example, the PCC colour of Example 3 of the invention and the conventional PCC colour of Comp. Example 1, were each applied to a sheet of paper as in Example 9. After drying and calendering, the coated paper sheets were folded and the foldings examined. The coating of the invention exhibited a markedly reduced number of cracks, as compared to the conventional coating.

### Example 14

In this example, paper was coated using a draw-down coating applicator, and the gloss obtained with the coating colour of Example 3 of the invention was compared to that of a conventional kaolin clay colour (Comp. Example 7), using Dispex as the dispersant, in which colour the PCC had been replaced with clay in order to improve the gloss. After light calendering, the coated paper using the PCC containing colour exhibited higher gloss compared to the coated paper using the clay containing colour.

TABLE 7
Gloss value of coated paper

| Designation | Gloss unit |
|---|---|
| Example 3 | 44.3 |
| Comp. Example 7 | 40.7 |

### EXAMPLE 15

A coating colour of a total solids content of 60 wt % was prepared by uniformly blending 0.42 g (0.30%) of a hydrophobically modified carboxymethyl cellulose (HM-CMC) as described in WO 98/56825, having a degree of substitution of carboxy methyl groups around 0.95, a degree of substitution of C4 alkyl groups around 0.1 a degree of substitution of C14 alkyl groups around 0.006, a molecular weight distribution between 20000 and 70000 g/mol, and a solids content of 86.3%, 46.96 g of deionized water, 150 g of rhombohedral precipitated calcium carbonate with a solids content of 80.5% manufactured by Huber Engineered Materials, 26.83 g (11%) of a 50% dispersion of SB latex (Baystal™ P7105 manufactured by Eka Polymer Latex) and 1.13 g (0.75%) of CMC with a solids content of 89.4% (Finnfix™ 10 manufactured by Noviant).

The temperature dependent behaviour of the PCC colour containing HM-CMC, were examined using a rheometer model UDS200 from PAAR Physica. The temperature tests were performed between 25 and 85° C. within the linear viscoelastic region.

TABLE 8
The storage modulus at various temperatures for coating
with HM-CMC.

| Temperature (° C.) | Storage modulus, G′ (Pa) |
|---|---|
| 25 | 100 |
| 35 | 187 |
| 45 | 254 |
| 55 | 421 |
| 65 | 573 |
| 75 | 726 |
| 85 | 1180 |

The PCC colour with HM-CMC and a conventional PCC colour from Comp. Example 2, were also compared. The colours were each applied to a sheet of paper using a draw-down coating applicator and the gloss value of the coated paper sheets were measured after drying and soft calendering

TABLE 8
The gloss value of coated paper.

| Designation | Gloss value for soft calendered paper |
|---|---|
| Comp. Example 2 | 34 |
| Example with HM-CMC | 43 |

It appears that a higher gloss can be achieved using a HM-CMC as dispersing agent compared to the conventional coating colour of Example 2.

1. An aqueous slurry or dispersion of pigment particles comprising as dispersant an amphiphilic polymer at least partly adsorbed to the pigment particles, wherein the slurry or dispersion exhibits a temperature dependent viscosity in such way that the viscosity increases at least with a factor of about 2 when the temperature is raised from about 20 up to about 100° C.

2. A slurry or dispersion as claimed in claim 1, wherein the viscosity increases at least with a factor of about 5 when the temperature is raised from about 30 up to about 80° C.

3. A slurry or dispersion as claimed in claim 1, wherein the solids content of the slurry or dispersion is above about 60 wt %.

4. A slurry or dispersion as claimed in claim 1, wherein the Brookfield viscosity below 20° C. is from about 50 to about 5000 mPas.

5. A slurry or dispersion as claimed in claim 1, wherein the pigment particles are inorganic and weakly charged.

6. A slurry or dispersion as claimed in claim 5, wherein the pigment particles are selected from the group consisting of clay, TiO₂, calcium carbonate, and mixtures thereof.

7. A slurry or dispersion as claimed in claim 1, wherein the average molecular weight of the amphiphilic polymer is from about 2000 to about 200000.

8. A slurry or dispersion as claimed in claim 1, wherein the amphiphilic polymer comprises hydrophilic groups selected from the group consisting of charged anionic moieties, PEO/PPO, and mixtures thereof.

9. A slurry or dispersion as claimed in claim 8, wherein the amphiphilic polymer comprises hydrophilic groups of which at least some are charged.

10. A slurry or dispersion as claimed in claim 9, wherein the charged hydrophilic groups are selected from the group consisting of sulphonates, phosphonates, carboxylates, and mixtures thereof.

11. A slurry or dispersion as claimed in claim 1, wherein the amphiphilic polymer is selected from the group consisting of copolymers comprises alternating hydrophobic and hydrophilic residues along a backbone.

12. A slurry or dispersion as claimed in claim 11, wherein hydrophilic anchoring groups are positioned along the backbone.

13. A slurry or dispersion as claimed in claim 11, wherein the hydrophobic residues are C₁ to C₂₀ carbon chains.

14. A slurry or dispersion as claimed in claim 1, wherein the amphiphilic polymers is selected from the group consisting of an acrylic ester copolymers having pendant hydrophobic chains, hydrophilic chains, and exhibiting phosphonic acid or carboxylic acid as anions.

15. A slurry or dispersion as claimed in claim 1, wherein the amphiphilic polymers is selected from the group consisting of hydrophobically modified carboxymethyl cellulose.

16. A slurry or dispersion as claimed in claim 1, wherein the amphiphilic polymers is selected from the group consisting of polyurethane copolymers exhibiting at least one carboxylic acid residue as an anionic moiety.

17. A slurry or dispersion as claimed in claim 1, wherein the amphiphilic polymers is selected from the group consisting of alpha olefin/maleic acid copolymers exhibiting at least one carboxylic acid residue as an anionic moiety.

18. A process for the preparation of an aqueous slurry or dispersion of pigment particles comprising a step of mixing pigment particles, water and an amphiphilic polymer that becomes at least partly adsorbed to the pigment particles to obtain a slurry or dispersion exhibiting a temperature dependent viscosity in such way that the viscosity increases at least with a factor of about 2 when the temperature is raised from about 20 up to about 100° C.

19. A coating colour composition comprising an aqueous slurry or dispersion of pigment particles containing as dispersant an amphiphilic polymer at least partly adsorbed to the pigment particles, and at least one additive selected from the group consisting of binders, co-binders, rheology modifiers, foam depressants, optical brightening agents, pH adjusting agents, lubricants, preservatives and insolubilisers, wherein the coating colour composition exhibits a temperature dependent viscosity in such way that the viscosity increases at least with a factor of about 2 when the temperature is raised from about 20 up to about 100° C.

20. A process for the preparation of a coating colour composition of the invention comprising the step of mixing a slurry or dispersion of pigment particles containing as dispersant an amphiphilic polymer at least partly adsorbed to the pigment particles and exhibiting a temperature dependent viscosity in such way that the viscosity increases at least with a factor of about 2 when the temperature is raised from about 20 up to about 100° C., with at least one additive selected from the group consisting of binders, co-binders, rheology modifiers, foam depressants, optical brightening agents, pH adjusting agents, lubricants, preservatives and insolubilisers.

21. A process for the preparation coated paper or paper board comprising the steps of:
(a) applying a coating colour composition to a paper or paper board web, said coating colour composition comprising an aqueous slurry or dispersion of pigment particles containing as dispersant an amphiphilic polymer at least partly adsorbed to the pigment particles, and at least one additive selected from the group consisting of binders, co-binders, rheology modifiers, foam depressants, optical brightening agents, pH adjusting agents, lubricants, preservatives and insolubilisers, and exhibiting a temperature dependent viscosity in such way that the viscosity increases at least with a factor of about 2 when the temperature is raised from about 20 up to about 100° C.; and,
(b) bringing said coating colour composition on the paper or paper board web to a temperature sufficient for increasing the viscosity of the coating colour composition at least with a factor of about 2.
